(19) United States
(12) Patent Application Publication
(10) Pub. No.: US 2025/0229980 A1
(43) Pub. Date: Jul. 17, 2025

(54) Wheeled Container Footing System and Method of Use

(71) Applicant: Peter McCrossin, Alexandria, VA (US)

(72) Inventor: Peter McCrossin, Alexandria, VA (US)

(21) Appl. No.: 18/703,213

(22) PCT Filed: Oct. 19, 2022
(86) PCT No.: PCT/IB2022/060065

§ 371 Date: Apr. 19, 2024

Related U.S. Application Data
(60) Provisional application No. 63/257,261, filed on Oct. 19, 2021.

(51) Int. Cl. B65F 1/12; B65F 1/02; B65F 1/14; B65F 1/16

(52) U.S. Cl. CPC B65F 1/12; B65F 1/02; B65F 1/1473; B65F 1/16; B65F 2220/12; B65F 2220/124; B65F 2250/114

(57) ABSTRACT

A container system 101, comprising: a wheeled container 103 having: a body with wheels 104, a lower surface 105 and a side surface 106; recessed opening 102 extending from the lower surface into the side surface; footing 113 having a contouring of the recessed opening, and the recessed opening accommodating the contouring of the footing; wherein the footing is pivotally attached to the container within the recessed opening.

### BACKGROUND

### Field of the Invention

The present invention relates generally to a wheeled container footing system and method of use.

### Discussion of the Background

Wheels were added to the trash can in the late 1960's to reduce the strain and consequent injuries connected to dragging and lifting heavy loads above the users' hips in order to empty them. As a result, the wheeled containers (sometimes referred to as, “wheelie bins”) gradually increased in size allowing larger loads to be disposed of with relative ease. The introduction of refuse trucks using mechanical arms to automatically secure, lift and empty the bins allowed for very large and very heavy loads to become routine in most neighborhoods. Because of the large capacity of the wheelie bins, the idea of adding a footing system to the bins was unnecessary as removal of the load by hand would be beyond most peoples' capabilities.

Fifty years since the introduction of the wheelie bin, a recent and growing trend in wheelie bin production and sales is a considerable reduction in size and capacity making the removal of heavy loads more manageable for the average user. These smaller bins are not designed for use with the automatic arms of a refuse truck. As a result, the user now faces the awkward task of emptying the bin by hand, which is often deeper than the average user's reach.

Conventional systems for containers have openings and footings on opposite sides of each other. Locating footings and recessed openings on opposite sides of the container (that is, at an angle of 180° to each other) makes it difficult and sometimes nearly impossible for a person to simultaneously stand on both footings without falling over. Systems with recessed steps, which require the user to insert the foot to hold the container down are also inconvenient and difficult to use—as it requires the user's leg to be fully extended straight against the side of the container. Further, the size of the foot recess that protrudes into the container reduces container volume and interferes with the telescopic nesting and stacking of the containers for storage and shipping.

### DESCRIPTION OF THE DRAWINGS

Referring now to the drawings wherein like reference characters identify corresponding or similar elements throughout the several views, FIGS. 1-22 depict various embodiments of the present invention. It should be understood that the embodiments discussed herein are substantially similar in form and function and share one or more of the features discussed in each embodiment although the features may not be shown specifically with reference to the particular embodiment.

FIG. 1 is an oblique view of the system of the present invention, showing a container system 101, a wheeled container 103 having a body with wheels 104, a lower surface 105 and a side surface 106; recessed opening 102 extending from the lower surface into the side surface; footing 113 having a contouring of the recessed opening, and the recessed opening accommodating the contouring of the footing; wherein the footing is pivotally attached to the container within the recessed opening. A wheeling handle 108 is also shown, for pulling or pushing the wheeled container.

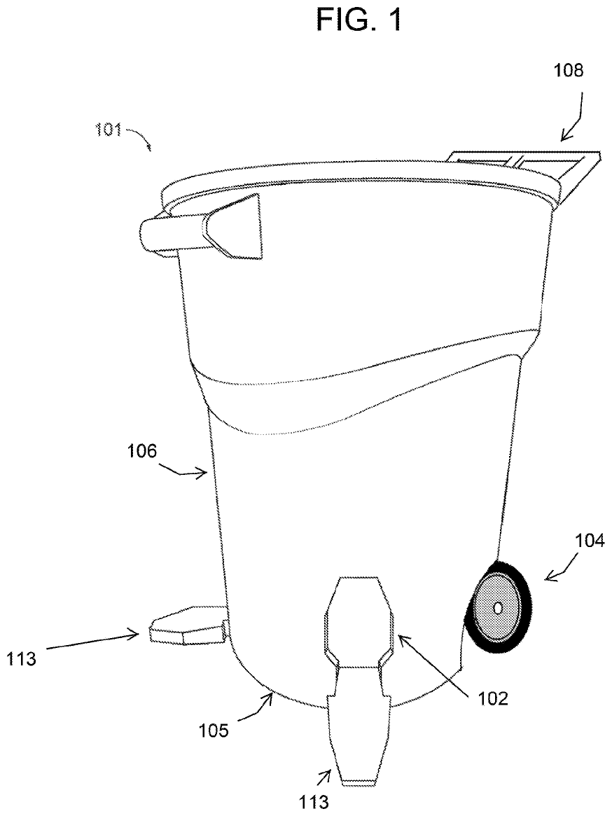

FIG. 2 is a front view of the system shown in FIG. 1, with both footings 113 folded down from the recessed openings 102 and resting on the ground or supporting surface.

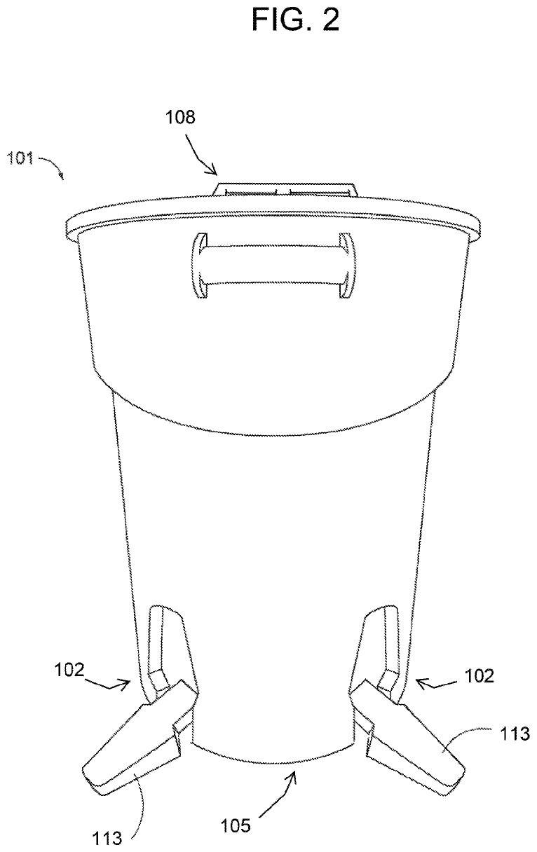

FIG. 3 is a front view of the system shown in FIG. 1, with one footing 113 folded down and the other footing 113 folded in the upright position.

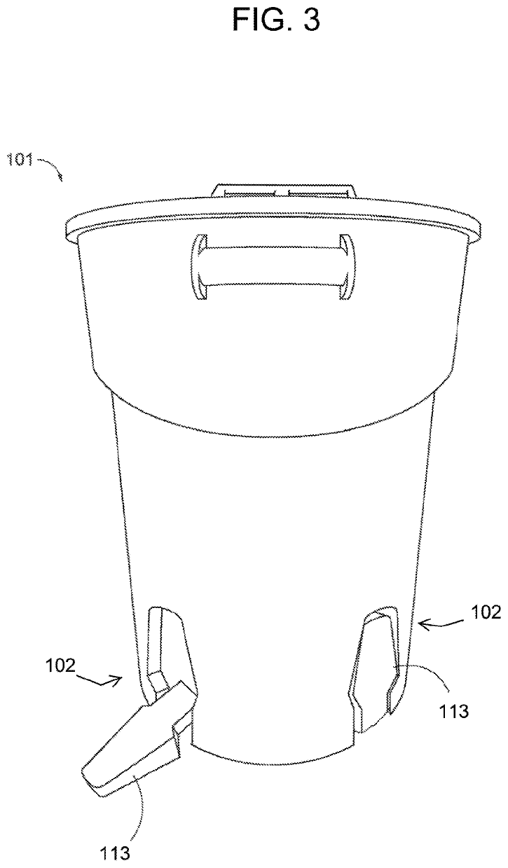

FIG. 4 is a front view of the system shown in FIG. 1, with both footings 113 folded in the upright position into recessed openings 102. So folded, the footings 113 are flush or substantially flush with the side surface 106 to permit easy storage or telescopic stacking and nesting with other containers.

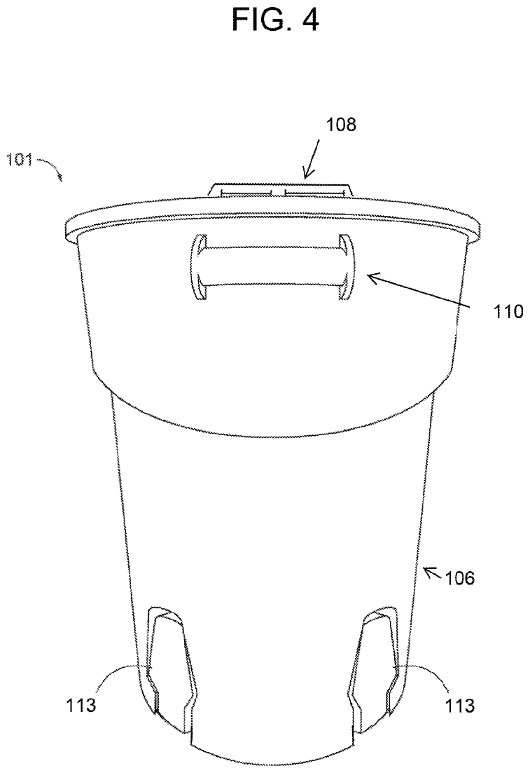

FIG. 5 is a front disassembled view of an embodiment of the system shown in FIG. 1. Embodiments of footings 113 and recessed openings 102 are shown, denoted as footings 115 and 117 and respective corresponding recessed openings 109 and 117. On the right-hand side of the figure, footings 115 and 117 are shown in plan and elevation. The bottom-right shows footings 115 and 117 with hinge pin tabs 119 protruding from each side. The recessed openings each include a recessed hinge portion 111, which in the embodiment shown is a pair of opposing holes configured to receive hinge pin tabs 119 of footings 115 and 117, whereby the wherein the footings is pivotally attached to the container within the recessed openings. FIG. 5 also shows footings 115 and 117 in elevation view in their upright position. The flat side is the foot-stepping surface, and the curved side is ground-contacting surface shown (curve exaggerated) to approximately match the contour of the side surface 106 when folded in the upright position.

FIG. 6 shows a front view of an embodiment of recessed opening 102 and recessed hinge portion 111. In the embodiment shown the recessed hinge portion 111 is a pair of opposed hinge knuckles which may snap-fit around or otherwise pivotally retain hinge pin tabs 119 or other hinge pins such as 120, 121.

FIG. 7 shows a front view of a disassembled embodiment of the footing 117 with hinge pin tabs 119 and corresponding recessed opening 102 in relevant part with recessed hinge portion 111. In the embodiment shown the recessed hinge portion 111 is a pair of opposed hinge knuckles which may snap-fit around or otherwise pivotally retain hinge pin tabs 119 or other hinge pins such as 120, 121.

FIG. 8 shows an embodiment of recessed opening 102 with recessed hinge portion 111. In the Enlightenment shown, the recessed hinge portion is a pair of opposed female hinge loops, which accommodate or pins hinge pin on a footer.

FIGS. 9A and 9B show an embodiment of recessed opening 102 with recessed hinge portion 111 and hinge pin 121 held captive. The hinge pin 121 may be removably snap-fit into recessed hinge portion 111 or be permanently captive. FIG. 9B shows an embodiment of the corresponding footing 122, which includes a hinge pin receiving knuckle 123 for engaging with hinge pin 121. Hinge pin receiving knuckle 123 may be removably snap-fit onto hinge pin 121, or it may be permanently captive. The downward-facing hinge pin receiving knuckle 123 engages over the top of hinge pin 121, and when stepped on by a user in the folded-down position, the footing 122 exerts downward pressure of the hinge pin 121 and recessed hinge portion 111 and thus on the container, preventing the container 103 from lifting up off the ground, for example, when a user is removing bags out of the container.

FIGS. 10A and 10B show an embodiment of recessed openings 102 with hinge pin tabs 125 extending from as part of the recessed hinge portion 111. FIG. 10B shows the footer 126 with a hinge pin tabs receiving knuckle 127 to rotatably engaged with hinge pin tabs 125.

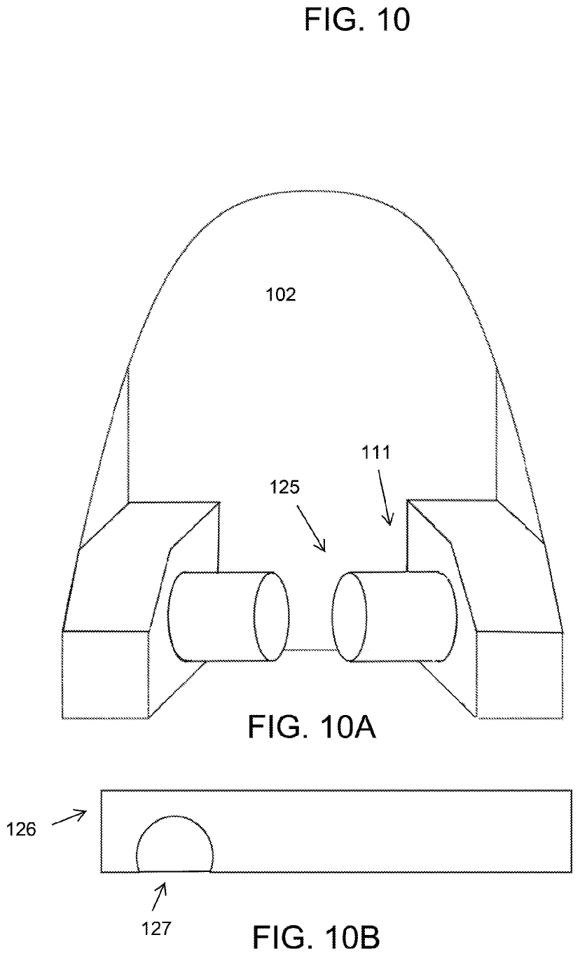

FIG. 11 shows the bottom portion of container system 101 and the angle θ between the two footings, formed by two imaginary axes shown as hatched lines drawn through the respective long axes of footings 113, and projected on the lower surface. Preferably, in the present invention, the angle θ for any two neighboring recessed openings 102 is less than 180° considering comfort and usability.

FIG. 12 shows an embodiment in partial cutaway of recessed opening 102 and footing 113 folded in the upright position into the recessed opening. The lower surface 105 and side surface 106 are shown.

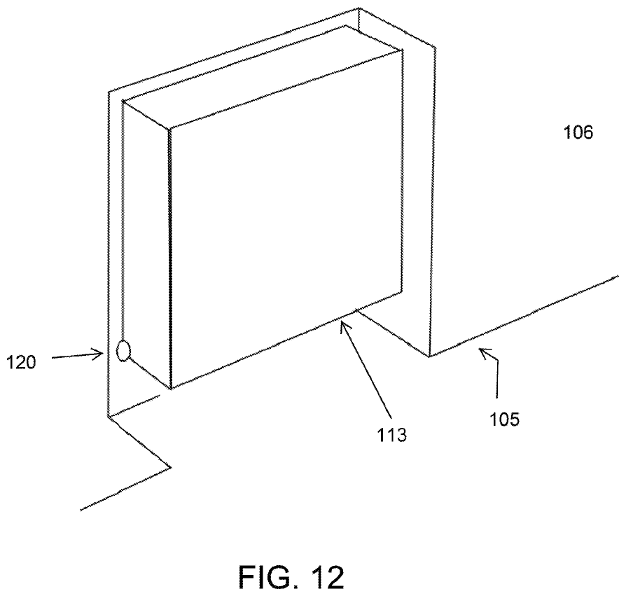

FIG. 13 shows an embodiment in partial cutaway of recessed opening 102 and footing 113 in the folded down position resting against the ground or supporting surface. The lower surface 105 and a side surface 106 of the container are shown. Also shown is a spring 130 in hinge 120. In preferred embodiments, the spring is biased to hold the footing 113 in the upright position.

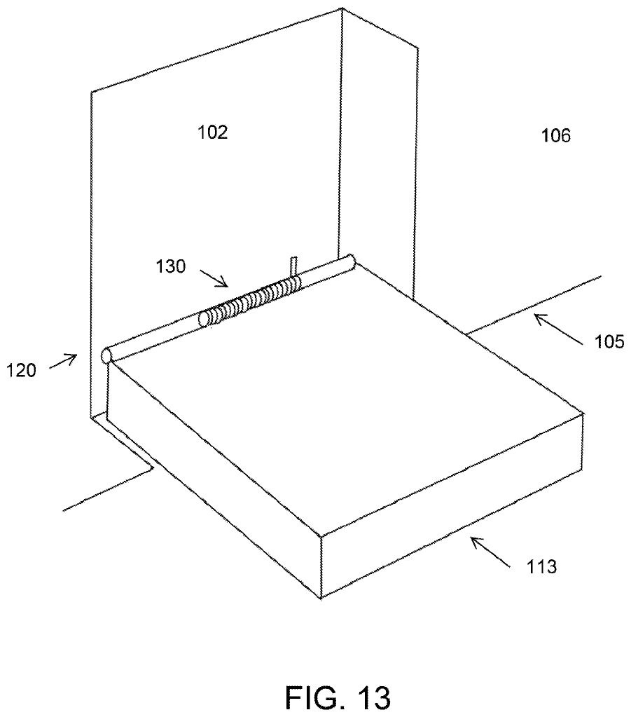

FIG. 14 shows an embodiment in partial cutaway of recessed opening 102 and footing 113 in the folded down position. Shown are respective magnets/metal mating surfaces 140 and 145, which engage each other magnetically when the footing is folded in the upright position. Also shown as spring 130 in hinge 120. In embodiments, the spring may be biased to hold the footing 113 in an open, folded down position, and the magnets/metal mating surfaces 140 and 145 act to counter the force of the open-biased spring 130 and hold the footing 113 in the upright position. In this way, the footer is held in the upright closed position when not in use; the user merely flips the footing 113 open, easily overcoming the magnetic force, and the spring holds the footing in the downward position, which may be convenient.

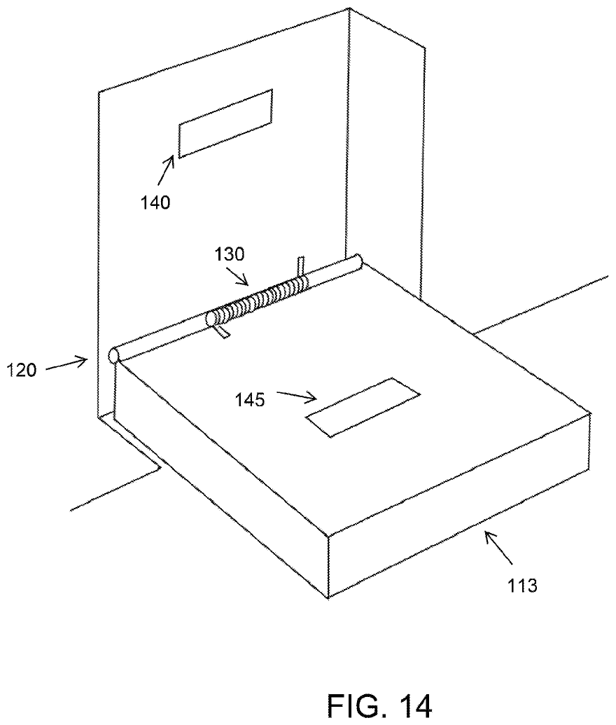

FIGS. 15A and B show a cross-section of an embodiment of the footing system, in which container wall 150 is shown in cross-section, with side surface 106 and lower surface 105. Footing 113 in FIG. 15A shown in the folded-up position around hinge 120. FIG. 15B shows footing 113 in the folded-down position from recessed opening 102.

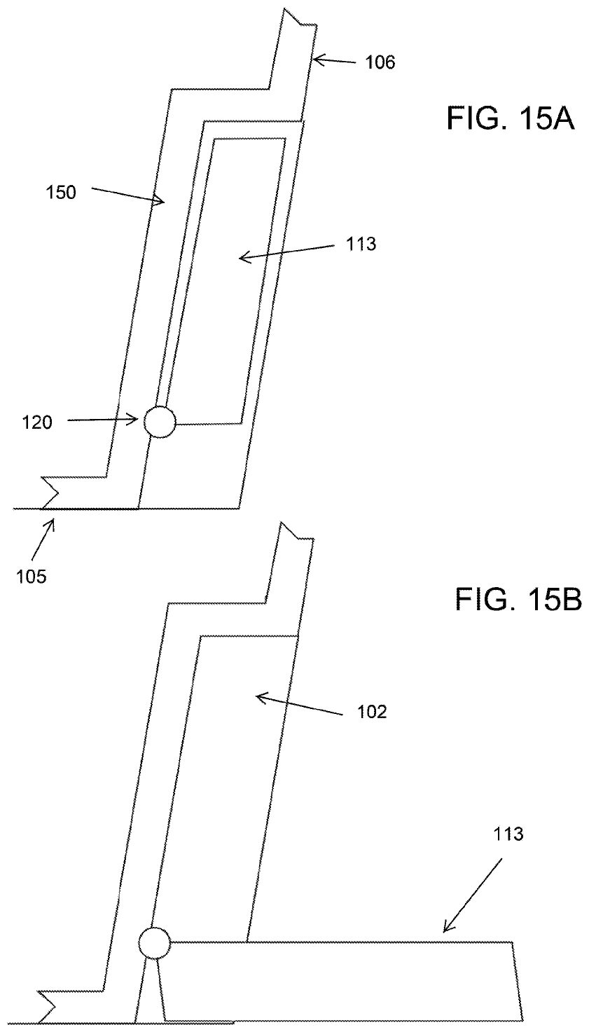

FIGS. 16A and B show a cross-section of an embodiment of the footing system, in which container wall 150 is shown in cross-section, with side surface 106 and lower surface 105. Footing 113 in shown in the folded-up and folded-down positions around hinge 120. In this embodiment, footing 113 has includes a receiving knuckle to accommodate a hinge pin, tab, or similar.

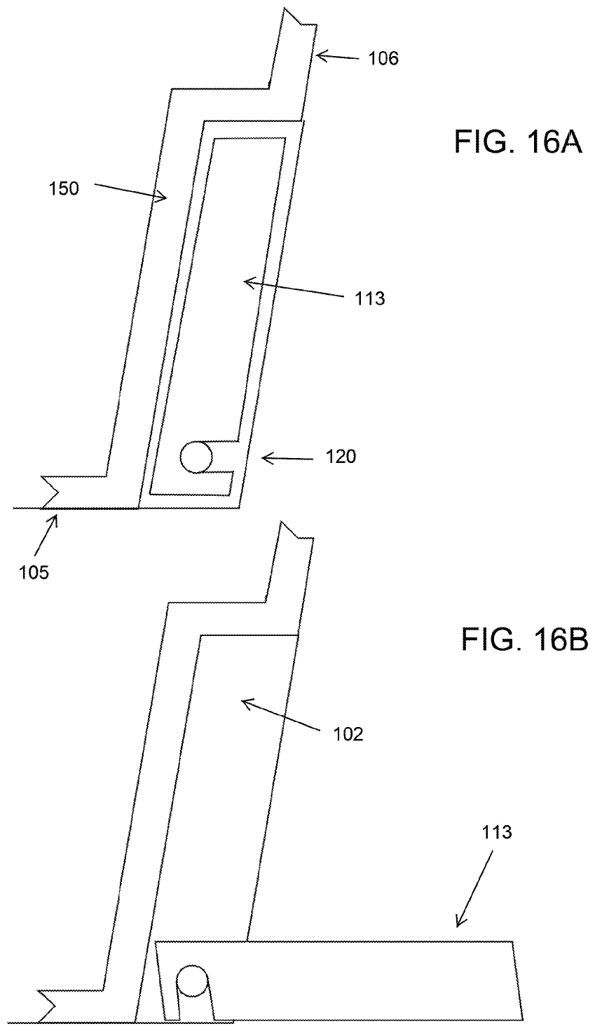

FIGS. 17A and B show alternate locations of the hinge 120 relative to the footing 113 and recessed opening 102.

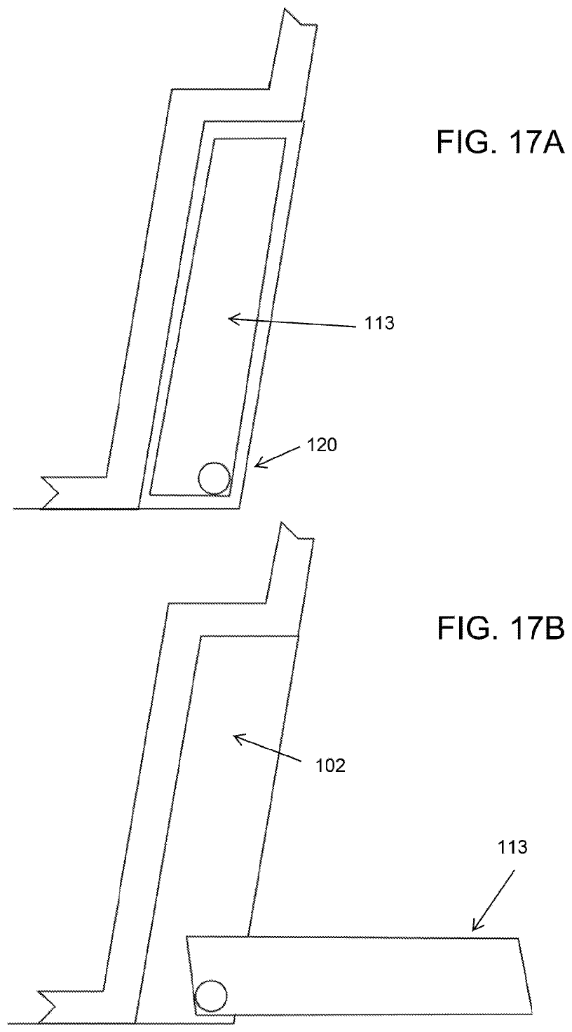

FIGS. 18A and B show a cross-section show a cross-section of an embodiment of the footing system, in which spring 130 is shown about hinge 120. Preferably, spring 130 biases the footing 113 in the upright, folded up position, and the user must maintain foot pressure to hold footing 113 in the folded-down position for use. It should be noted that the force of the spring is less than the force required to tip over the container, and need only exert sufficient force to hold the footing in the upright position for storage or when not in use. In other embodiments, it may be desirable for the spring to bias the footing in the open, folded-down position.

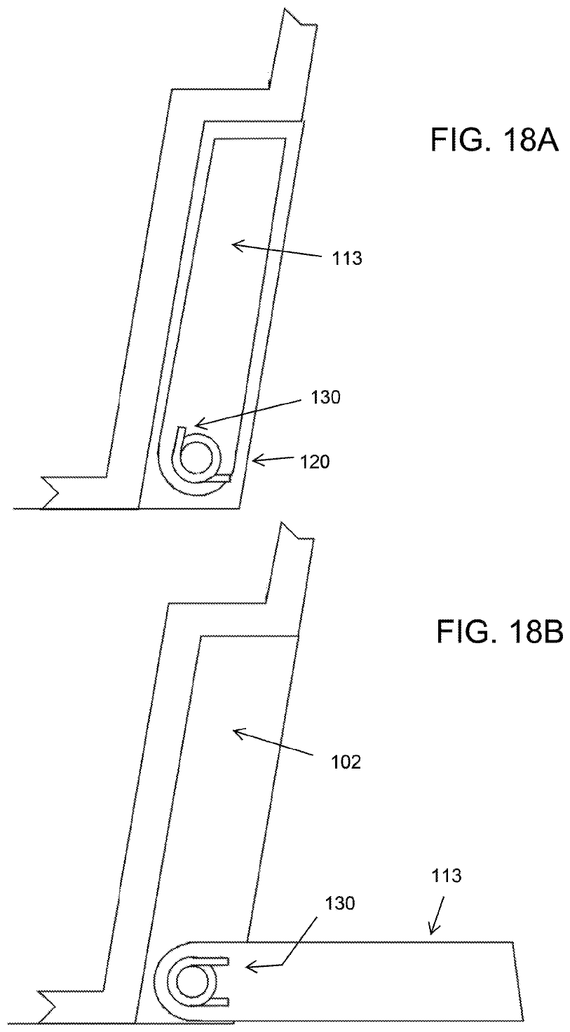

FIGS. 19A and B show a cross-section of an embodiment in which magnets/metal mating surfaces 140 and 145 are integrated into the container wall 150 in the recessed opening 102 and the footing 113. So arranged, the magnets hold the footing in an upright, folded-up position for storage or when not in use. For use, the user merely folds down the footing 113 to separate the magnet from the corresponding metal mating surface; the footing 113 will rest in the open, folded-down position for use.

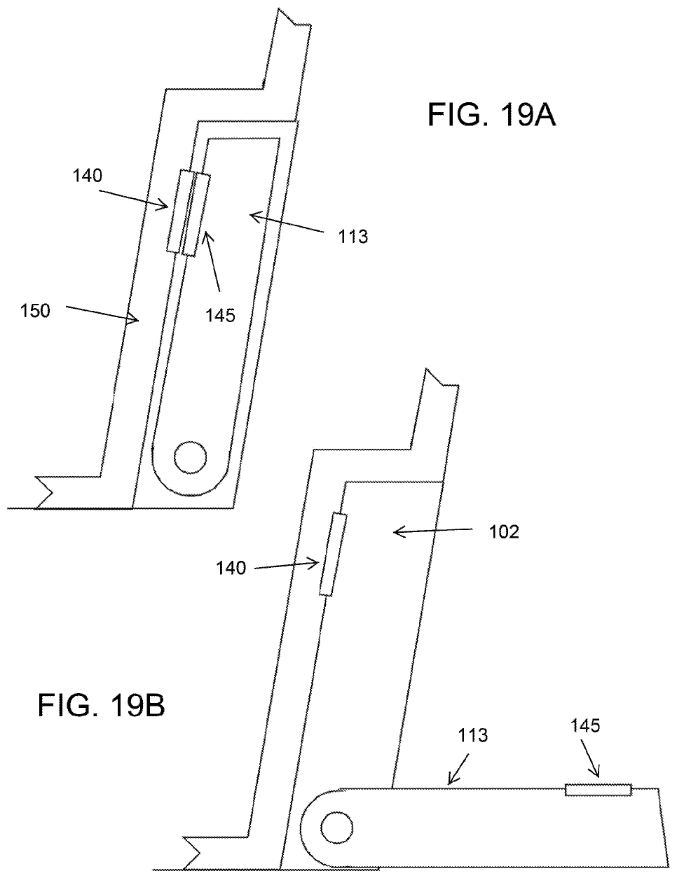

FIGS. 20A and B show in cross-section an embodiment in which footing 113 contains a counterweight/ballast 155 which exerts a downward force, represented by arrow “a”, up to act as a cantilever weight on footing 113 about hinge 122, to maintain footing 113 in an upright, folded up position. When in use, the user's foot pressure is sufficient to hold footing 113 in the open position.

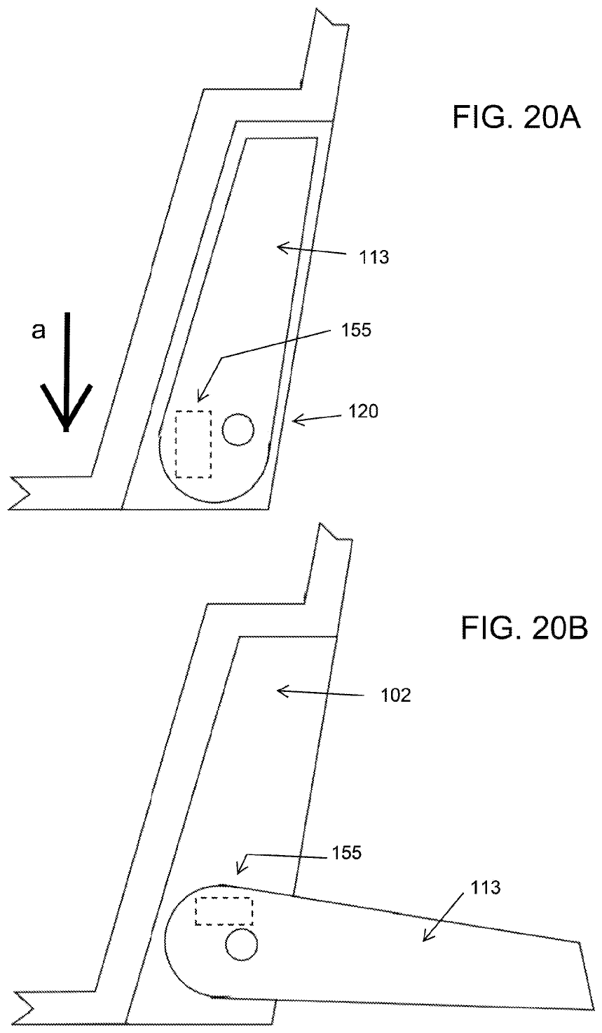

FIGS. 21A and B show in cross-section an embodiment in which footing 113 and recessed opening 102 include detents 160 which include a mating recess 163 and corresponding boss or raised portion 165. Mating recess 163 in the side of footing 113 or recessed opening 102 receives and engages with boss or raised portion 165 in the corresponding side of footing 113 or recessed opening 102 and acts as a soft stop to hold footing 113 in either an upright position (FIG. 21A) or in a folded-down position (FIG. 21B).

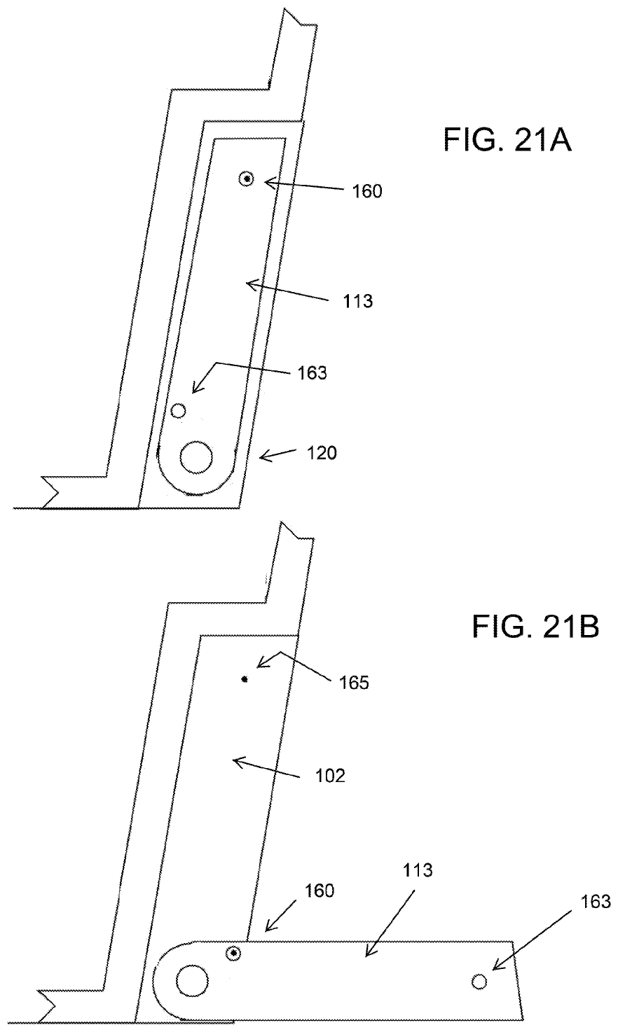

FIGS. 22A and B show in cross-section an embodiment in which footing 113 includes a foot peg 170 which protrudes from side surface 106. Foot peg 170 makes it easy for the user to extract footing 113 from the upright position and push it down into the open position with the user's toe. Foot peg 170 may be integrated into footing 113, for example formed of the same material, such as molded plastic, as footing 113. Alternatively, foot peg 170 may be a separate bracket attached to the footing 113.

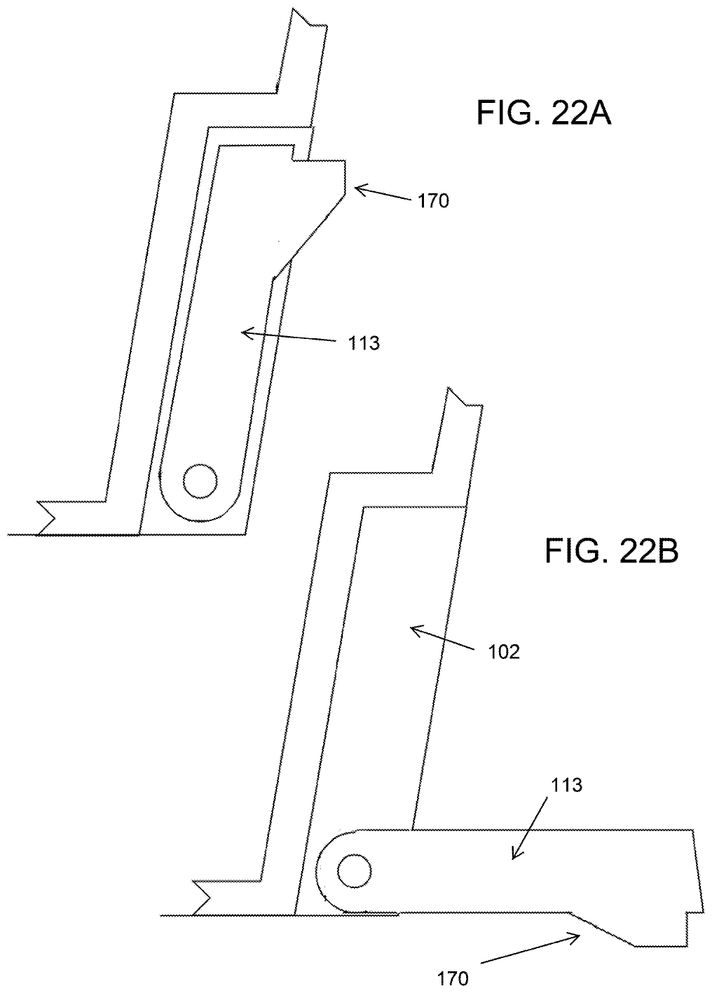

### GUIDE TO FIGURES

101 container system
102 recessed opening (generic)
103 wheeled container
104 wheels
105 lower surface
106 side surface
107 recessed opening
108 wheeling handle
109 recessed opening
110 front handle
111 recessed hinge portion
112 side handle
113 footing (generic)
115 footing
117 footing
119 hinge pin tabs
120 hinge
121 hinge pin
122 footing
123 hinge pin receiving knuckle
125 hinge pin with tabs
126 footing
127 hinge pin tabs receiving knuckle
130 spring
140 magnet/metal mating surface
145 magnet/metal meeting surface
150 container body wall
155 counterweight/ballast
160 detent, with boss and mating recess engaged
163 mating recess
165 boss
170 foot peg.

### BRIEF DESCRIPTION OF THE INVENTION

The present invention solves the aforementioned problems, and others. The containing footing system of the present invention desirably assists the user in the task of emptying the wheeled bin especially if the contents were placed inside a bin liner or trash bag. The footing system allows the can to be anchored while freeing up both arms to remove the bin's load. The footing system allows the wheeled can to be stabilized during removal of the bin's load, whereas otherwise the wheels would lead to tipping over of the can and instability.

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

A container system 101 is provided, comprising: a wheeled container 103 having: a body with wheels 104, a lower surface 105 and a side surface 106; recessed opening 102 extending from the lower surface into the side surface; footing 113 having a contouring of the recessed opening, and the recessed opening accommodating the contouring of the footing; wherein the footing is pivotally attached to the container within the recessed opening.

As used herein, “upright”, “up”, “down” refer to directions as the container is upright and sitting on the ground or supporting surface, and not necessarily strictly vertical. The lower surface 105 refers to the bottom or ground-contacting surface of the container. The side surface 106 refers to the side surface of the container and does not imply a particular front, back, left or right sides.

Preferably, the wheels are rotatably engaged with the body at an opposite side surface of the recessed opening.

In embodiments, the wheeled container further comprises a lid.

Preferably, the wheeled container further comprises a wheeling handle 108 and, optionally, one or more other handles. Front and side handles 110 and 112 may be included.

Preferably, the container is stackable-telescopically nesting with other containers.

The container can include one recessed opening 102 and one corresponding footing 113. Preferably, the container system includes two recessed openings 102 and two corresponding footings 113.

The container can be made of any material, which is not particularly limited. The container may be metal or plastic. Preferably, the container body is a heavy duty plastic suitable for trash bins or similar containers. Similarly, the handles, wheels and footings, and parts of the recessed openings may be made of the same material. Hinges and hinge pins, tabs, and the like may be made from the same heavy duty plastic material or a different material such as metal, such as steel or aluminum. Preferably, the container body is made from heavy-duty plastic material.

The container system body may be cylindrical, square, rectangle, tapered, or combination thereof.

Preferably, the container system includes two recessed openings 102 that pivotally accommodate footings 113.

Preferably, the wheels are rotatably engaged with the body generally at an opposite side surface of the recessed opening and second recessed opening. Here, “opposite side surface” generally intends that the wheels are on one side of the container, and the recessed openings 102 and footings 113 are on the general other side of the container.

Preferably, the footing pivots upward into an upright position within the recessed opening 102 to be flush with the side surface 106.

Preferably, the footing 113 pivots downward into an open position extending outward from the recessed opening 102 and the side surface to accommodate a user's foot standing on the footing.

The footing 113 may be either removable or permanently attached to the container at the hinge 120. So long as it is suitable for the described use, the hinge 120 is not particularly limiting. Examples of hinges include pin with knuckle or loop, leaf, butt, spring-loaded, self-opening or closing, concealed, or the like. Preferably, the footing 113 may be removably snap-fit to the recessed hinge portion 111 of the recessed openings 102.

The footing may be removably attached to the container at the hinge 120, which hinge is not particularly limiting. Some examples with a snap-fit attachment, gudgeon and pintle attachment, male member and female receiving member, removable pin or clevis pin hinge pin, interlocking snap-fit or the like.

Preferably, the footing 113 is spring-loaded, whereby the footing, when not engaged by a user's foot, is held in an upright position by a spring 130.

In some embodiments, the recessed opening comprises one or more detents, which cooperate and engage with respective detents in the footing, whereby the footing is held in an upright position, or in a folded-down position for use.

In embodiments, the footing 113 comprises a counterweight/ballast 155, whereby the footing, when not engaged by a user's foot, is held in an upright position, by a cantilever effect of the weight on footing 113.

In embodiments, the footing 113 and recessed opening 102 include corresponding magnets/metal mating surface 140 and 145, which cooperate with each other to hold the footing 113 in the upright or folded down position. They may be integrated into the footing and recessed opening, or attached to the footing and recessed opening with adhesive, fasteners, snap-fit or the like. Alternatively, one surface of either the footing 113 or recessed opening 102 can be made of metal.

A method of disposing trash is provided, comprising placing trash inside the container system.

In embodiments, footing 113 and recessed openings 102 can include any combination of spring 130, magnet/metal mating surfaces 140, 145, detent 160, and counterweight/ballast to bias the footing 113 into either the folded-up or folded-down position.

Preferably, footing 113 is held upright into the recessed openings 102 by a spring 130.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

As described herein, one embodiment of the present invention is drawn to a container system, which includes: a wheeled container having: a body with wheels, a lower surface and a side surface; a first recessed opening extending from the lower surface into the side surface; a first footing having a contouring of the recessed opening, and the recessed opening accommodating the contouring of the first footing; wherein the first footing is pivotally attached to the container within the recessed opening.

As shown in the drawings, the present invention is related to a footing system configured to engage with a side of a wheeled container, which in the preferred embodiment, is a wheeled garbage can. In one of the preferred embodiments, the footing is configured to pivotally attach to the side of the wheeled container, which in turn allows the user to step thereon to secure the container to the ground surface. In some contemplated embodiments, the footing is configured to removably engage with the side of the wheeled container at various heights; accordingly, the footing is contemplated being pivotally attached at a designated location while also being configured to being secured at various heights relative to the ground surface.

One embodiment includes a container having wheels and with a body having a lower surface with two or more openings configured to hold one or more respective footing apparatuses therein. In the preferred embodiment, the apparatus includes a footing configured to pivotally fit within respective openings and pivot therein via one or more tabs that extend from the body of the footings and configured to engage with holes disposed within the openings.

In an alternative embodiment, the system utilizes two footing apparatuses positioned on sides of the container at positions other than opposing sides, such that the footings can be comfortably accessed by one or both of the user's feet.

One embodiment provides a system 101 include a wheeled container 103 with a body having a lower surface 105 with two or more recessed openings 107, 109 configured to hold one or more respective footing apparatuses 113 therein. In the preferred embodiment, the footing apparatus 113 (e.g., footing 115 and footing 117) configured to pivotally fit within respective recessed openings 102 (e.g., recessed openings 109, 107) and pivot therein via one or more tabs 119 that extend from the body of the footings and configured to engage with recessed hinge portion 111 disposed within the openings.

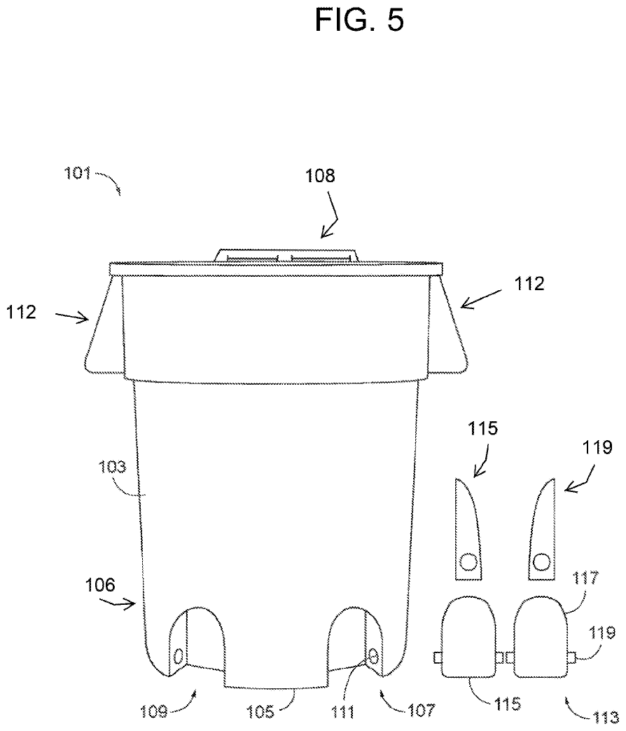

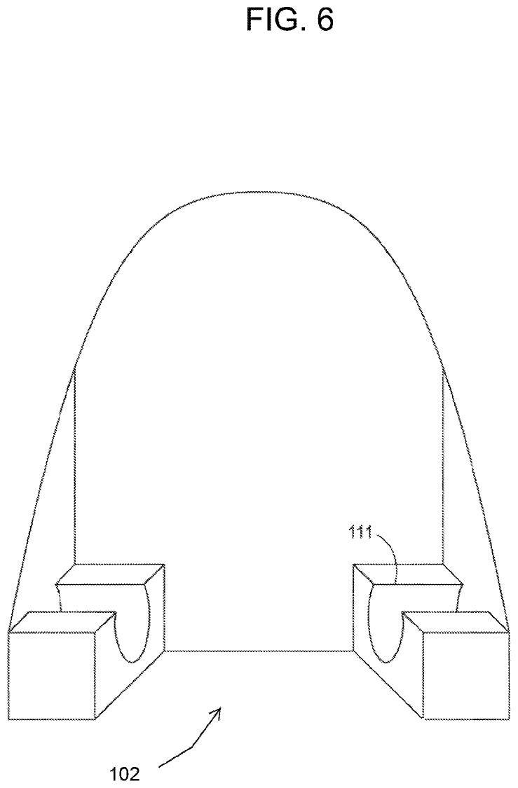

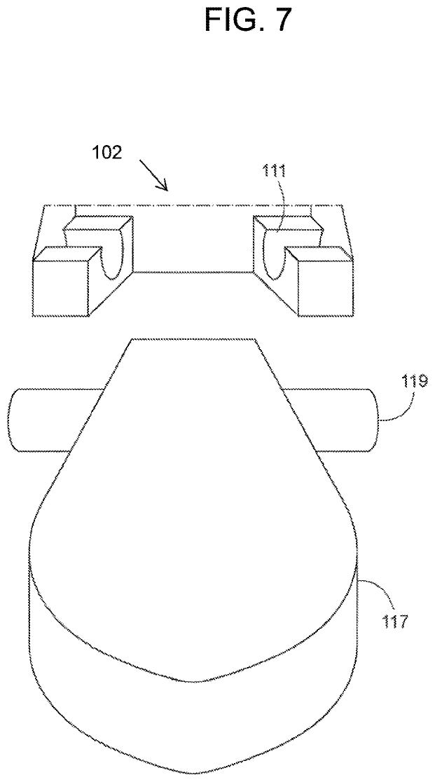

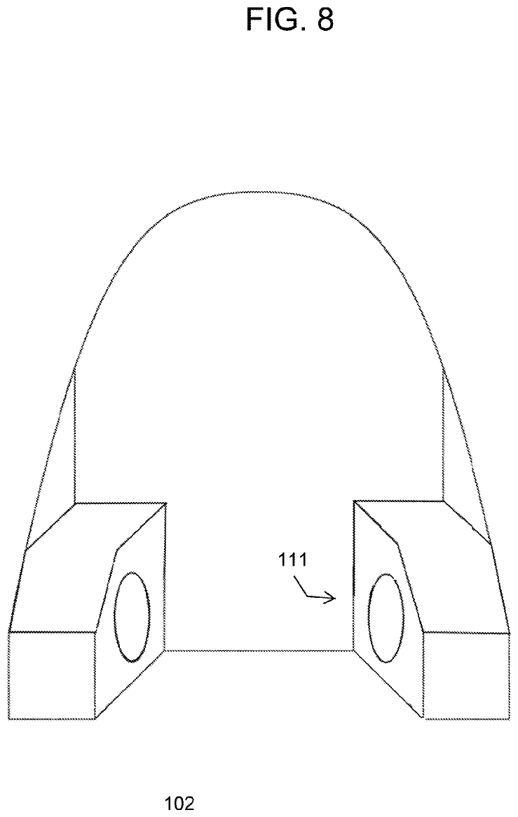

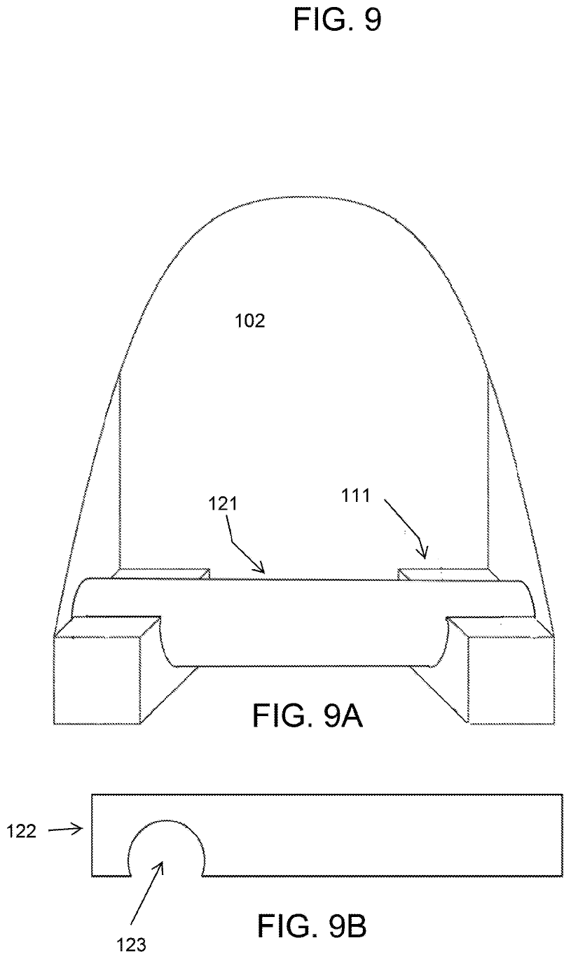

The recessed hinge portion 111 may pivotally accommodate the corresponding hinge portion, tabs, pins, loops, or knuckles on the corresponding footing 113. The recessed hinge portion 111 may have a female receiving part, or have a male inserting part, a snap-fit receiving part, may be removable or permanently fixed. The recessed hinge portion 111 is set in the recessed opening 102 and cooperates with the footing 113 to pivotally attach the footing 113 to the container within the recessed opening 102. In an embodiment, the recessed hinge portion 111 engages tabs 119 completely, such as shown, for example, at FIGS. 5 and 8, or partially, such as shown in FIGS. 6 and 7. The partially accommodating holes may receive the tabs 119 or hinge pin 121, such as shown in FIG. 9.

The recessed hinge portion 111 and tabs 119, hinge pins 121 and 125 and knuckles 123 and 127 cooperate generally to form hinge 120 pivotally connecting the footings to the container within the recessed openings.

In a preferred embodiment, the recessed openings and footings are at an opposite side of the container relative to the side having the wheels. The recessed openings and footings are not on opposite sides of each other. As discussed above, locating footings and recessed openings on opposite sides of the container (that is, at an angle of 180° to each other) it is impossible for a person to simultaneously stand on both footings without falling over.

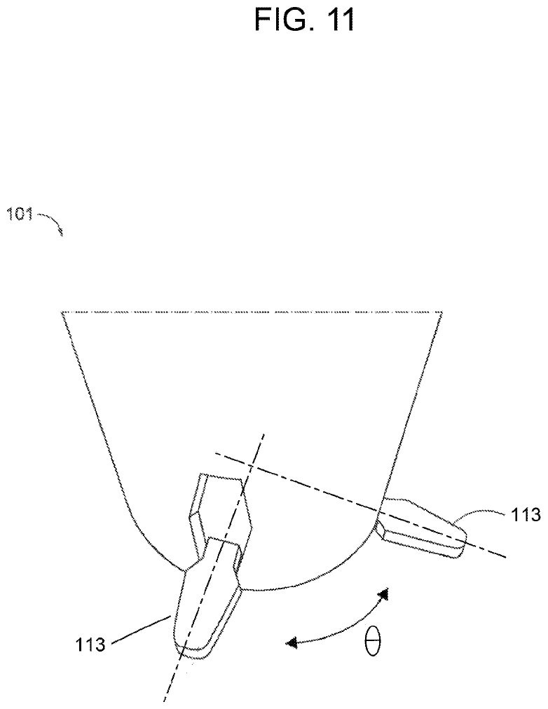

In the present invention, up when two footings are present, they and their respective recessed openings are located generally on an opposite side of the container from the wheels. In considering standing comfortably on both footings and safely unloading bags and the like from the container, when two footings are present, they are located at an angle of less than 180° relative to each other. This is shown in FIG. 11, wherein the angle θ between the two footings, that is, between the two imaginary axes drawn through the footings on the lower surface, is shown. So long as the pair of footings meet at an angle of less than 180°, the angle θ is not particularly limiting, and may preferably be 160, 140, 120, 100, 90, 80, 60, and 40°, and any range therebetween. In embodiments, the footings meet at an angle θ of 40-100°

The present invention is not limited to two footings, however. If desired, the container system may include three or four footings. In such cases, when three or four footings are present, they may be located at any position along the side surface and are not limited by the location of the wheels or one another.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

The contents of U.S. Pat. No. 10,906,698, issued Feb. 2, 2021, are hereby incorporated by reference.

This application is based upon and claims the benefit of U.S. Application No. 63/257,261, filed Oct. 19, 2021, the contents of which are hereby incorporated by reference.

What is claimed is:

1. A container system 101, comprising: a wheeled container 103 having: a body with wheels 104, a lower surface 105 and a side surface 106; recessed opening 102 extending from the lower surface into the side surface; footing 113 having a contouring of the recessed opening, and the recessed opening accommodating the contouring of the footing; wherein the footing is pivotally attached to the container within the recessed opening.

2. The container system of claim 1, wherein the wheels are rotatably engaged with the body at an opposite side surface of the recessed opening.

3. The container system of claim 1, wherein the wheeled container further comprises a lid.

4. The container system of claim 1, wherein the wheeled container further comprises a wheeling handle 108 and, optionally, one or more other handles.

5. The container system of claim 1, which is stackable.

6. The container system of claim 1, further comprising a second recessed opening 109 extending from the lower surface into the side surface, and a second footing 115 having a contouring of the opening, wherein the second footing is pivotally attached to the container within the second opening.

7. The container system of claim 1, further comprising a second recessed opening 109 extending from the lower surface into the side surface; a second footing 115 having a contouring of the second recessed opening, and the second recessed opening accommodating the contouring of the second footing; wherein the second footing is pivotally attached to the container within the second recessed opening, and wherein the wheels are rotatably engaged with the body at an opposite side surface of the recessed opening and second recessed opening.

8. The container system of claim 1, wherein the footing pivots upward into an upright position within the recessed opening to be flush with the side surface.

9. The container system of claim 1, wherein the footing pivots downward into an open position extending outward from the recessed opening and the side surface to accommodate a user's foot standing on the footing.

10. The container system of claim 1, wherein the footing is removable.

11. The container system of claim 1, wherein the footing is removably attached to the container with a snap-fit attachment, gudgeon and pintle attachment, male member and female receiving member, or the like.

12. The container system of claim 1, wherein the container body is made from heavy-duty plastic material.

13. The container system of claim 1, wherein the body is cylindrical, square, rectangle, tapered, or combination thereof.

14. The container system of claim 1, wherein the footing 113 is spring-loaded, whereby the footing, when not engaged by a user's foot, is held in an upright position by a spring.

15. The container system of claim 1, wherein the footing 113 and recessed opening 102 comprise one or more detents, which cooperate and engage with one another, whereby the footing is held in an upright position.

16. The container system of claim 1, wherein the footing 113 comprises a counterweight/ballast 155, whereby the footing, when not engaged by a user's foot, is held in an upright position, by the weight.

17. The container system of claim 1, wherein the footing 113 and recessed opening 102 comprise magnet/metal mating surfaces 140 and 145, which cooperate and engage with one another, to hold the footing 113 in an upright position.

18. A method of disposing trash, comprising placing trash inside the container system of claim 1.
